(19) United States
(12) Patent Application Publication
(10) Pub. No.: US 2008/0165068 A1
(43) Pub. Date: Jul. 10, 2008

(54) Artificial dielectric rotman lens

(76) Inventor: Eric David Caswell, Sevem, MD (US)

Correspondence Address: BRINKS HOFER GILSON & LIONE, P.O. BOX 10395, CHICAGO, IL, 60610, US

(21) Appl. No.: 11/650,299

(22) Filed: Jan. 5, 2007

(51) Int. Cl. H01Q 3/46

(52) U.S. Cl. 343/753

(57) ABSTRACT

An Artificial Dielectric Rotman Lens (ADRL) provides smaller size and reduced weight relative to conventional Rotman Lens embodiments. The ADRL includes the same input ports, output ports and dummy termination ports as a conventional Rotman Lens. The ADRL internal construction, however, is significantly different with multiple printed circuit board layers forming regions having effective permittivities that are much greater than the individual printed circuit board constitutive parameters.

### BACKGROUND

The present invention relates generally to beam forming devices and methods. More particularly, the present invention relates to an artificial dielectric Rotman Lens.

A Rotman Lens is a parallel plate device used for beam forming in conjunction with a linear array of radiating antenna elements. A Rotman Lens is used to excite an antenna array and allow a receiver or transmitter such as a radio, a radar, a jammer, etc., to choose between a plethora of antenna beams. A Rotman Lens is disclosed in U.S. Pat. No. 4,381,509 to Rotman, et al.

FIG. 1 illustrates a conventional Rotman Lens 100. The conventional Rotman Lens includes beam input ports 102, beam output or antenna ports 104, dummy or load ports 106, a parallel plate region 108 and transition regions 110. The Rotman Lens 100 is formed using a printed circuit board 112 having metallization on a dielectric material, such as Rogers FR4 or other suitable material. The input ports 102 are placed along a first side 120 of the board 112 forming the Rotman Lens. The output ports 104 are positioned along an opposite 122 of the board 112. The dummy ports 106 are located along the other sides 124, 126 of the board 112.

In the conventional Rotman Lens, typically one or more input ports 102 are selected and/or combined, thus causing a distribution of RF energy across the output ports 104. Dummy ports 106 are used on the sides of the lens 100 and are ultimately loaded with lossy terminations to reduce reflections. By selection of respective input ports, certain output ports are also selected. A beam of energy leaves the Rotman Lens at a particular azimuth depending on the selected output ports. Thus, a variety of beams each with a different azimuth may be formed using the Rotman Lens 100.

FIG. 2 illustrates a number of beams created by an array of antenna elements that have been connected to the output ports of the conventional Rotman Lens 100 of FIG. 1. FIG. 2(a) shows performance at 760 MHz and FIG. 2(b) shows performance at 2200 MHZ. It can be seen that respective beams are produced at selected azimuth regions and, at other azimuth regions, the respective beams are substantially suppressed by as much as 20 dB. The input and output connections may have amplifiers and/or attenuators in order to accomplish various beamforming functions required by the antenna array. These functions include, for example, low sidelobes, minimum signal to noise, and so forth.

The conventional Rotman Lens 100 of FIG. 1 is typically manufactured using conventional printed circuit fabrication processes. Such processes start with a single layer circuit board with copper cladding on both sides. Metal cladding is chemically etched off one side of the circuit board to form a pattern such as the pattern shown on the board 112 of FIG. 1.

The Rotman lens is a unique beamforming architecture in that it allows connection to one of many simultaneous independent beams formed by an array of antenna elements. The size of the lens may be reduced by using materials in the parallel plate region that have high permittivities. These include low loss ceramic materials.

FIG. 3 shows cross section views of the conventional Rotman Lens of FIG. 1. FIG. 3(a) shows a cross section taken through the parallel plate region 108 in FIG. 1. FIG. 3(b) shows a cross section through the transition region 110 in FIG. 1. The board 112 includes a dielectric layer 302 with a first metallization 304 on the first side and second metallization 306 on the second side. In the transition region 110 shown in FIG. 3(b), a connector 308 is positioned on the second side to electrically and mechanically couple an input signal to the board 112.

One problem in the conventional structure of FIG. 1 and FIG. 3 is that, as the number of input and output ports increases, the physical size of the Rotman Lens must also increase. However, increasing physical size is contrary to many design goals of physical systems incorporating Rotman Lenses. In order to reduce size, several researchers have used higher dielectric materials to construct the Rotman Lens. Examples of such materials have relative permittivities of as much as 100.

However, most useful printed circuit board materials have a relative permittivity in the range of 2 to 10. Circuit board materials with relative permittivities greater than 10 or so are not readily available and can have a high fabrication cost. A high fabrication cost is also contrary to many design goals of systems incorporating Rotman Lenses. Some ceramic materials have exhibited low loss but may not be fabricated in a large sheet form factor as would be needed for use in a Rotman lens.

Accordingly, there is a need for an improved Rotman Lens device and method providing improved functionality at least as good as current lenses and reduced physical size and cost.

### BRIEF SUMMARY

By way of introduction only, the present invention is directed to a Rotman lens and an artificial dielectric material therefore.

In one embodiment, a Rotman lens includes input ports, output ports and a parallel plate region which includes an artificial dielectric material. Transition regions are located between the input ports and the output ports and the parallel plate region. The parallel port region has a relative permittivity of approximately 75 for frequencies from 600 to 2600 MHz.

In another embodiment, a Rotman lens includes a printed circuit board which has a plurality of dielectric layers and a plurality of conducting layers. One or more arrays of capacitive elements are formed from the dielectric layers and the conducting layers to define a parallel plate region of the Rotman lens. Input ports and output ports are disposed on the printed circuit board and transition regions are located between the parallel plate region and the input ports and the output ports.

FIG. 4 shows a comparison of a conventional parallel plate region, FIG. 4(a) with an artificial dielectric parallel plate region, FIG. 4(b), in accordance with one aspect of the disclosure herein. By using layers of metallic patches which are closely spaced to the outer conductors and connected to the opposing conductor layer by conducting vias as shown, a much larger relative permittivity than that achieved by conventional material layers is possible.

As discussed above in conjunction with FIG. 3, the parallel plate region of the conventional Rotman Lens includes a dielectric region 302 sandwiched between two metal layers 304, 306. The dielectric layer 302 supports propagating fields characterized by the equation E₀^{-jkx} as a dominant mode. As will be described in greater detail below, the parallel plate region of the improved Rotman Lens in accordance with the embodiments disclosed herein includes a plurality of vias and patches separating multiple dielectric layers. The improved parallel plate region is characterized by the equation E₀^{-γkx} as a dominant mode.

The foregoing discussion of the preferred embodiments has been provided only by way of introduction. Nothing in this section should be taken as a limitation on the following claims, which define the scope of the invention.

### BRIEF DESCRIPTION OF THE DRAWINGS

FIG. 1 illustrates a conventional Rotman Lens;

FIG. 2 illustrates beams from a linear array of antenna elements connected to the conventional Rotman Lens of in FIG. 1;

FIG. 3 shows cross section views of a parallel plate region and a transition region of the conventional Rotman Lens of in FIG. 1;

FIG. 4 compares a conventional parallel plate region with an artificial dielectric parallel plate region in accordance with an improved Rotman Lens;

FIG. 5 illustrates the unloaded medium of an improved Rotman Lens;

FIG. 6 illustrates a loaded medium of an improved Rotman Lens and an equivalent model;

FIG. 7 illustrates terms and models used in an exemplary analysis;

FIG. 8 illustrates wave propagation in the loaded medium of FIGS. 5 and 6;

FIG. 9 shows ε_{eff} plotted as a function of frequency for the example embodiment illustrated in FIGS. 5 and 6;

FIG. 10 shows ωd vs. βd and ε_{eff} plotted as a function of frequency when loading is reduced (C_{LOAD}=¼ C_{CELL};

FIG. 11 shows ωd vs. βd and ε_{eff} plotted as a function of frequency when cell pitch patch area are increased (d from 0.06 to 0.10 and A from 0.002 to 0.004);

FIG. 12 shows ωd vs. βd and ε_{eff} plotted as a function of frequency for an alternative embodiment (d=0.08 and A increased 1.3×);

FIG. 13 shows ωd vs. βd and ε_{eff} plotted as a function of frequency for an additional alternative embodiment (d=0.10 and A=1.7×);

FIG. 14 is an alternative embodiment of an artificial dielectric for a Rotman Lens;

FIG. 15 is an alternative embodiment of an artificial dielectric for a Rotman Lens;

FIG. 16 is an alternative embodiment of an artificial dielectric for a Rotman Lens; and

FIG. 17 illustrates a preferred embodiment of an artificial dielectric for a Rotman Lens device;

FIG. 18 is a top view of a transition region of an artificial dielectric Rotman Lens;

FIG. 19 is a top view of a second embodiment of a transition region of an artificial dielectric Rotman Lens. and

FIG. 20 illustrates a Rotman Lens.

### DETAILED DESCRIPTION OF THE PRESENTLY PREFERRED EMBODIMENTS

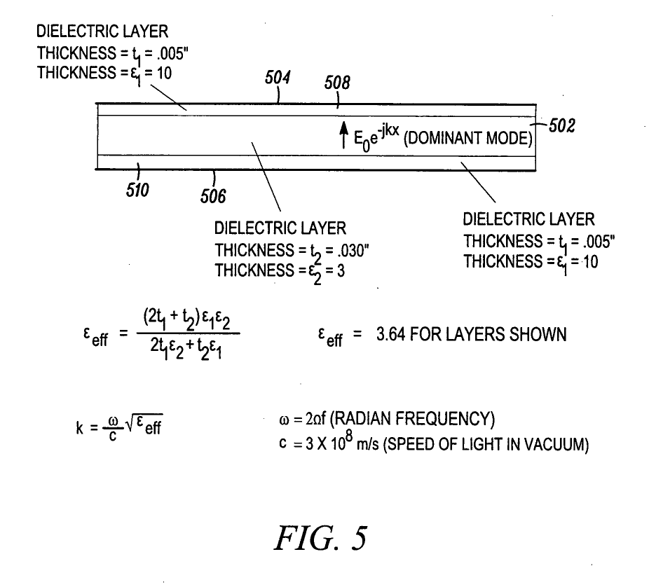

The analysis and description of the improved Rotman Lens begins by analyzing the configurations in FIG. 4 in detail. FIG. 5 shows a single dielectric slab 502 sandwiched between two conducting surfaces 504, 506. Two thin layers of dielectric, 508, 510, which may be different than the slab 502, are also included for this example. The dielectric slab 502 has a thickness t₂, set at 0.030 inches in the example of FIG. 5, and a relative permittivity ε₂ of 3 in this example. The thin layers of dielectric, 508, 510 have exemplary thicknesses t₁, set at 0.005 inches and relative permittivities ε₁ of 10.

As indicated in the figure, the effective permittivity,

$${ɛ}_{eff} = \frac{( 2 {t}_{1} + {t}_{2} ) {ɛ}_{1} {ɛ}_{2}}{2 {t}_{1} {ɛ}_{2} + {t}_{2} {ɛ}_{1}} ,$$

of the unloaded material configure of FIG. 5 is a function of each layer thickness and its associated permittivity. For this example, ε_{eff}=3.64. The dominant mode of wave propagation of concern has the electric field transverse to the slab 502 and normal to the conducting surfaces 504, 506. The wave propagation constant, k, is related to the radian frequency (ω), the speed of light in vacuum (c) and the effective permittivity as shown in FIG. 5. If losses are present, the complex form of permittivity (ε′-jε″) may be used which results in a complex number for k.

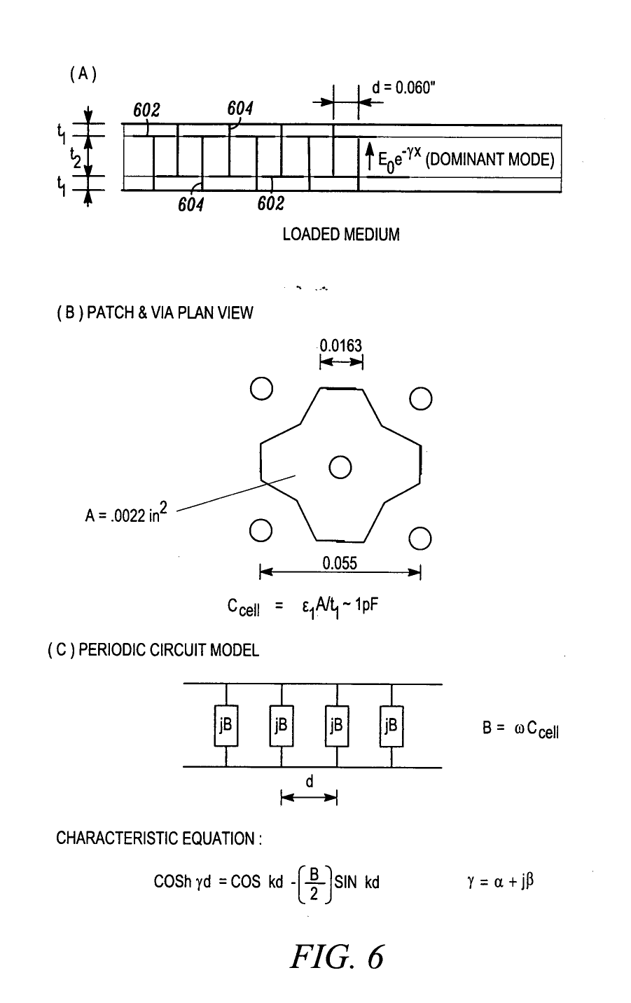

FIG. 6 shows an embodiment of an artificial dielectric parallel plate region 600 with alternating patches 602 connected by conducting vias 604 to the conducting layers. This embodiment may be referred to as the loaded medium, FIG. 6(a). The dielectric 600 includes a slab and thin layers in accordance with the discussion of FIG. 5, above. FIG. 6(a) shows a cross section through the parallel plate region 600. FIG. 6(b) shows a top view of a patch 602 and a via 604. FIG. 6(c) shows a circuit model.

The patches 602 in one embodiment are formed by depositing and etching metal from the surface of the dielectric slab. The patches 602 are usually spaced apart a constant period distance, d, and can have virtually any shape which makes up the patch area A, as shown in FIG. 6(b). In the example of FIG. 6, distance d=0.060 inches and the area=0.0022 square inches. The vias may be formed by drilling holes and filling the holes with conductive material such as copper. In other embodiments, the vias are formed in any suitable manner. The pitch or spacing of the vias may be any suitable value.

Each patch area realizes a cell capacitance, C_{cell}, as given by the equation in FIG. 6(b). That is, assuming an infinite periodic lattice of cells containing capacitive loads in the parallel plate region, a transmission line model as shown in FIG. 6(c) is appropriate with repetitive capacitive susceptances loading the line. Each capacitive susceptance B is defined as B=ωC_{cell}. The capacitance per cell is estimated at C_{cell}=ε₁A/t₁ and is approximately equal to 1 pF for the example of FIG. 6. This yields a characteristic equation for the wave propagation constant, γ, as follows:

$$cosh γ d = cos kd - ( \frac{B}{2} ) sin kd$$

where γ=α+jβ.

Note that waves propagate as e^{-αx-jβx} along an arbitrary linear dimension x in the loaded medium of FIG. 6 and as e^{-jkx} in the unloaded medium of FIG. 5.

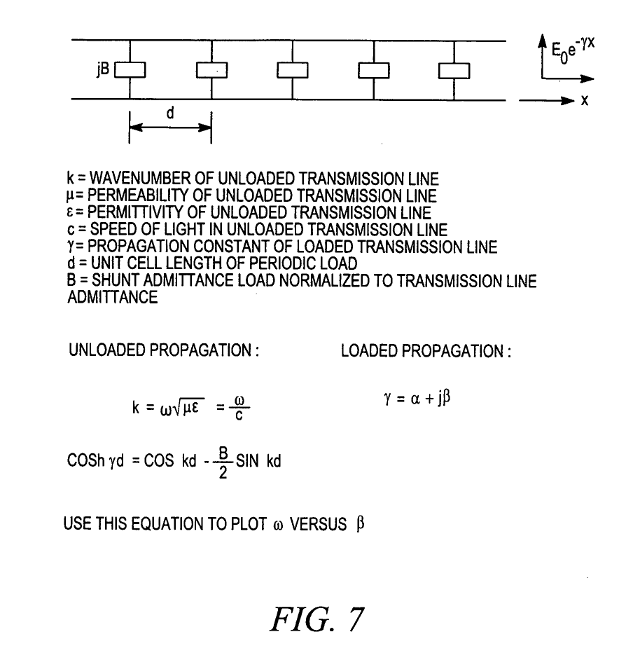

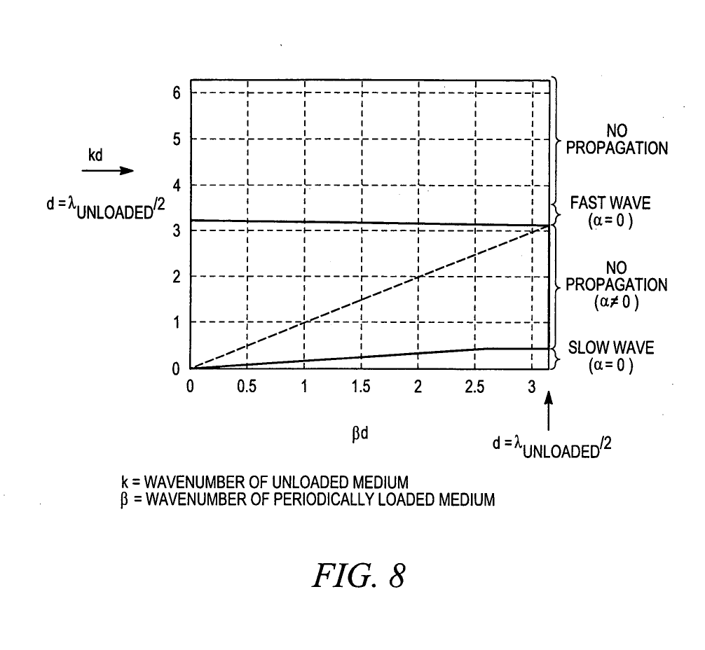

All of the terms used to characterize unloaded and loaded propagation of the dominant mode are summarized in FIG. 7 which allows us to view a normalized ω(kd) versus β(βd) plot. This is shown in FIG. 8 for the exemplary geometric and material parameters of FIGS. 5 and 6. The curve kd versus βd for the unloaded region is given by the dashed line in FIG. 8 and is always a substantially straight line. The curve kd versus bd for the loaded region is given by the solid lines in FIG. 8 and exhibits band gap regions where no unattenuated propagation occurs. These regions are labeled as α≠0.

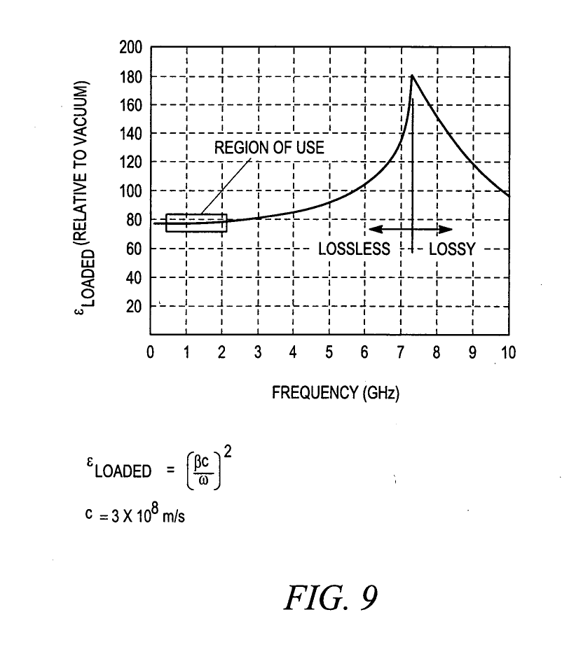

The desired region for operation for the present embodiments is the slow wave region where the wave appears to traverse a much greater electrical distance per unit length that it would in the unloaded medium. This is equivalent to having an effective homogeneous dielectric that is much greater than the unloaded medium permittivity. In this region, the effective permittivity may be determined from the propagation constant by the equation in FIG. 9.

FIG. 9 shows ε_{eff} plotted as a function of frequency for the example embodiment illustrated in FIGS. 5 and 6. A region of interest is highlighted indicating a region of maximum linearity of ε_{eff} versus frequency and a nominal permittivity value of 80 (relative to free space). The region of interest is in the range of about 0.5 GHz to 2.2 GHz. In this example, the slow wave (or lossless) mode exists up to 7.25 GHz, although the behavior is very nonlinear toward the high frequency range.

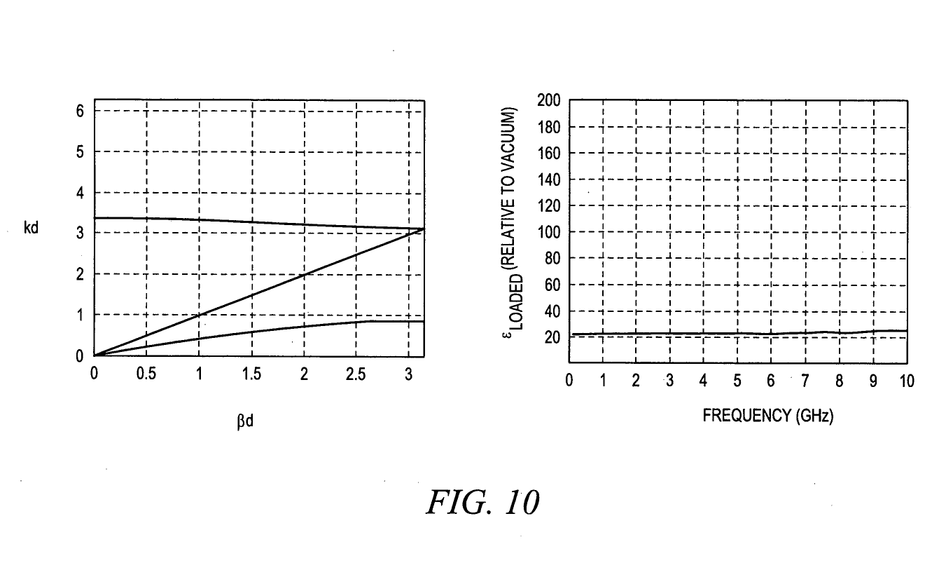

FIG. 10 shows ωd vs. βd and ε_{eff} plotted as a function of frequency when loading is reduced. That is, FIG. 10 illustrates what happens with the embodiment of FIGS. 5 and 6 when the capacitance per unit cell is decreased. In this example, cell capacitance is reduced by making the patch areas A smaller by a factor of 4. As expected, the loaded kd versus βd curve approaches the line kd=βd and the effective permittivity is reduced by a factor of 4.

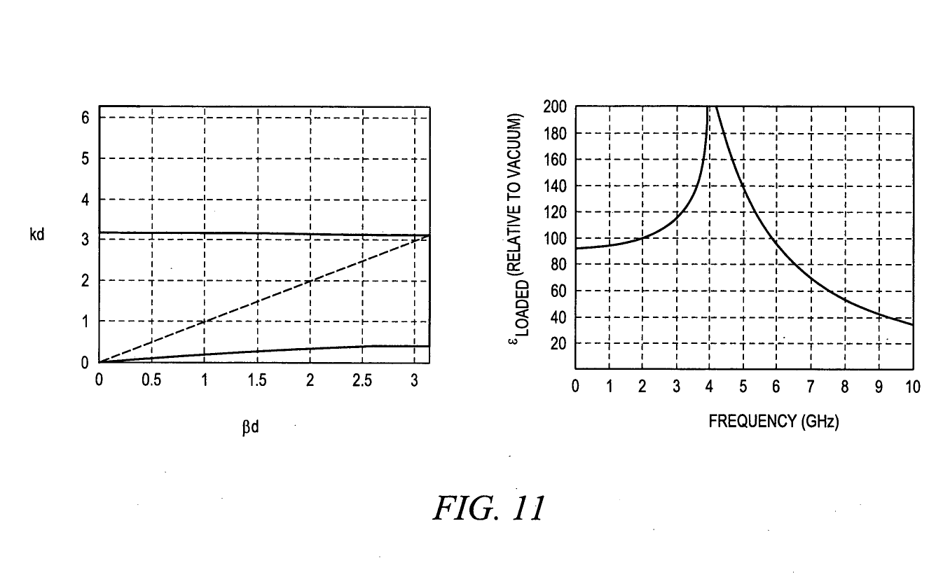

FIG. 11 shows ωd vs. bd and ε_{eff} plotted as a function of frequency when cell pitch is increased and patch area is increased. That is, FIG. 11 illustrates what happens when the cell period is increased to 0.1 in and the patch area is increased by a factor of 2. The effect of increasing patch area is that capacitance is increased. The increased capacitance results in greater permittivity and the larger cell size results in a lower frequency limit. Such trades may be considered to maximize linearity to a desired ε_{eff} while minimizing drill holes (and hence fabrication costs) required for the vias.

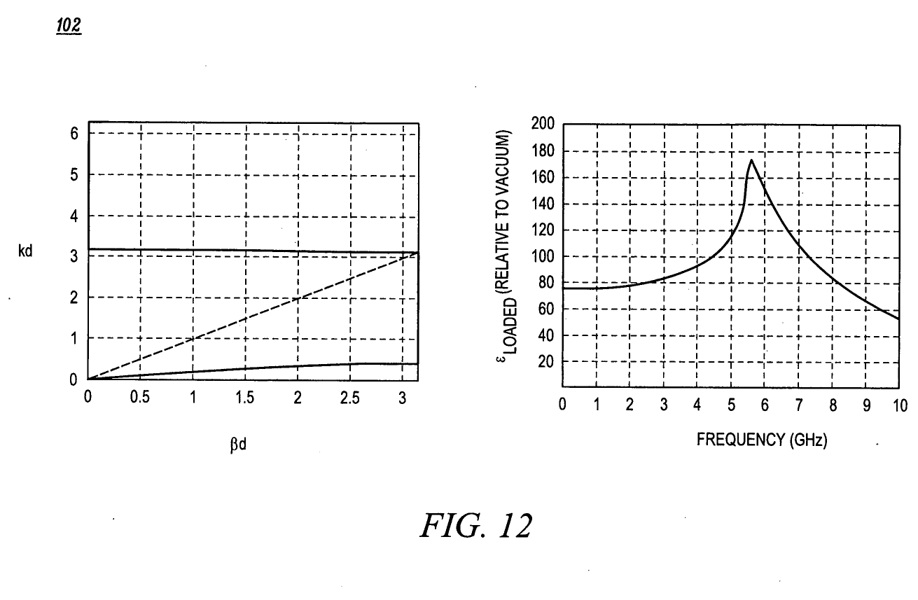

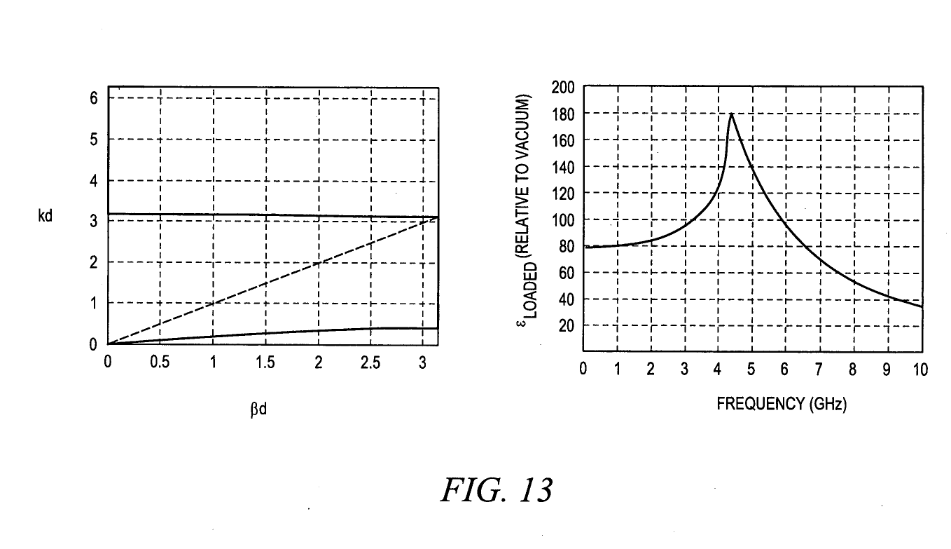

FIGS. 12 and 13 show additional variations to achieve an effective permittivity near 80 with maximum linearity and minimum fabrication cost. In the example of FIG. 12, the via spacing distance d is set to 0.080 inches and the patch area is set to 1.3 times the area value in the embodiment of FIGS. 5 and 6. In the example of FIG. 13, the via spacing distance d is set to 0.100 inches and the patch area is set to 1.7 times the area value in the embodiment of FIGS. 5 and 6. In both cases, as with FIG. 11, the increased capacitance results in greater permittivity and the larger cell size results in a lower frequency limit. These results may be used to develop or select other embodiments to satisfy particular design requirements.

This method of achieving an artificial dielectric parallel plate medium is not restricted to a periodic array of patches. Such a periodic array is only chosen to facilitate the analysis. In practice, an aperiodic array can be used or different periodicities may be used in different directions in the plane of the dielectric. Similarly, patch shape is arbitrary and may also change throughout the loaded medium. Other variations in structure and materials may be made as well.

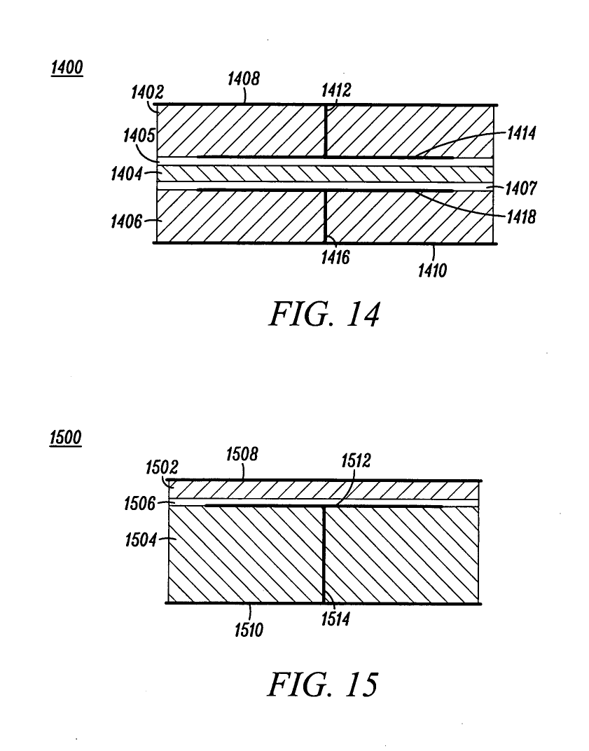

FIG. 14 shows an alternative embodiment of an artificial dielectric 1400 for a Rotman Lens which uses patches displaced symmetrically. FIG. 14 shows a symmetric single capacitive unit cell. The artificial dielectric includes a first dielectric 1402, a second dielectric 1404, an insulator 1405, a third dielectric 1406 and a second insulator 1407. The insulator 1405 separates the first dielectric 1404 from the second dielectric 1404 and the second insulator 1407 separates the second dielectric 1404 from the third dielectric 1406. A conductive plate or patch 1408 is disposed on the first dielectric 1408. Similarly, a conductive plate or patch 1410 is disposed on the second dielectric 1406. A conductive plate or patch 1414 is positioned between the first insulator 1402 and the second dielectric 1404 and a conductive via 1412 electrically shorts the conductive plate 1414 and the conductive patch 1408. A conductive plate or patch 1418 is positioned between the second insulator 1404 and the third dielectric 1406 and a conductive via 1416 electrically shorts the conductive plate 1418 and the conductive patch 1410. FIG. 14 illustrates a single unit cell of this embodiment.

FIG. 15 shows an asymmetric single capacitive layer unit cell 1500 for an artificial dielectric for a Rotman Lens. The embodiment of FIG. 15 includes a first dielectric 1502 and a second dielectric 1504. An insulator 1506 separates the first dielectric 1502 and the second dielectric 1504. A conductive layer 1508 is formed on the first dielectric and a second conductive layer 1510 is formed on the second dielectric layer 1504. A conductive patch 1512 is formed between the second dielectric 1504 and the first dielectric 1502. The conductive patch is electrically shorted to the second conductive layer 1510 by a via 1514.

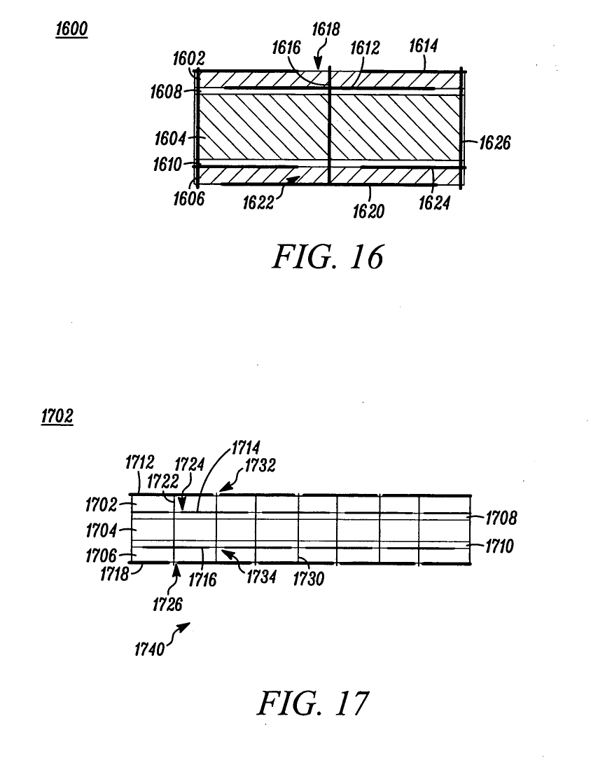

FIG. 16 shows a dual capacitive layer unit cell 1600 for an artificial dielectric for a Rotman Lens. The unit cell 1600 of FIG. 16 is symmetric but has a greater number of vias than the embodiment of FIG. 15. The unit cell 1600 includes a first dielectric 1602, a second dielectric 1604 and a third dielectric 1606. A first insulator 1608 separates the first dielectric 1602 from the second dielectric 1604. A second insulator 1610 separates the second dielectric 1604 from the third dielectric 1606.

The metallization includes a conductor 1614 on the surface of the first dielectric 1602 and a conductive patch 1620 on the surface of the second dielectric 1606. Within the structure, a patch 1612 is formed between the first insulator 1608 and the first dielectric 1602 and a patch 1624 is formed between the second insulator 1610 and the third dielectric. A via 1626 is shared between adjacent unit cells and electrically shorts conductor 1614 and patch 1624. A conductive via 1616 electrically shorts patch 1612 and conductive patch 1620. A spacer 1618 is formed in the metallization to isolate the conductor 1614 from the via 1616. Similarly, a spacer 1622 is formed in the patch 1624 to isolate the patch 1624 from the via 1616.

The preferred embodiment shown in FIG. 17 gives the highest permittivity with the greatest linearity and least fabrication cost. FIG. 17 illustrates a further embodiment of an artificial dielectric 1700 for a Rotman Lens device.

The artificial dielectric 1700 includes a first dielectric, a second dielectric 1704 and a third dielectric 1706. The artificial dielectric 1700 further includes a first insulating layer 1708 between the first dielectric 1702 and the second dielectric layer 1704 and a second insulating layer 1710 between the second dielectric layer 1704 and the third dielectric layer 1706.

In the exemplary embodiment, the first and second insulating layers 1708, 1710 may be formed of sheets of expanded PTFE impregnated with thermoset resins, sold for example under the brand name Gore Speedboard C prepreg from W.L. Gore and Associates. This material has an exemplary dielectric constant of 2.6 and may be obtained in thicknesses from 1.5 to 3.5 mils.

In the exemplary embodiment, the first dielectric 1702 and the third dielectric 1706 are each formed of a material conventionally referred to as 3010. The second dielectric 1704 in this embodiment is a sheet of 32 mil thick Rogers 4003 material having a dielectric constant of 3.38.

With respect to metallization, the artificial dielectric 1700 includes a first metal layer 1712 on the surface of the first dielectric 1702, a second metal layer 1714 between the first dielectric 1702 and the insulating layer 1708, a third metal layer 1716 between the second insulating layer 1710 and the third dielectric 1706, and a fourth metal layer 1718 on the surface of the third dielectric 1706. Conducting vias 1722 electrically couple patches formed of the third metal layer 1716 and patches formed of the first metal layer 1712. Spacer regions 1724 isolate the via 1722 from the second metal layer 1714. Similarly, relief holes or spacers 1726 isolate the via 1722 from the fourth metal layer 1718. A via 1730 electrically couples patches of the second metal layer 1714 and patches of the fourth metal layer 1718. Relief holes or spacers 1732 isolate the first metal layer 1712 from the via 1730 and spacers 1734 isolate the third metal layer 1716 from the via 1730.

The artificial dielectric 1700 can be describe as a unit cell 1740 repeated across the dimensions of the artificial dielectric 1700. For example, in the embodiment of FIG. 17, the unit cell may be defined to have physical boundaries beginning at the left edge of the artificial dielectric 1700 extending to include the via 1730. Vertically, the physical boundaries extend from (and include) the fourth metal layer 1718 to the first metal layer 1712. The unit cell is repeated any number of times across the structure of the artificial dielectric 1700. The unit cell may be repeated uniformly or with any suitable variation.

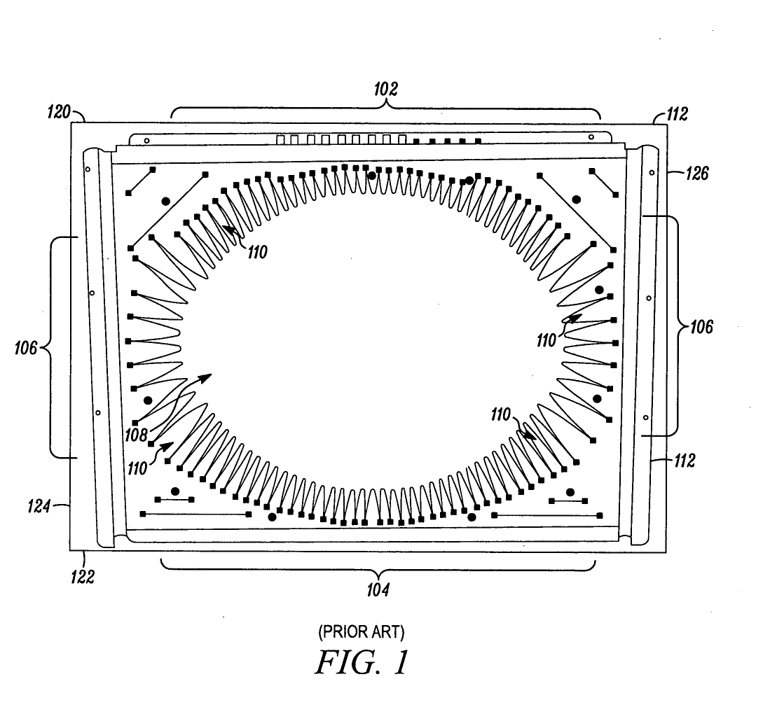

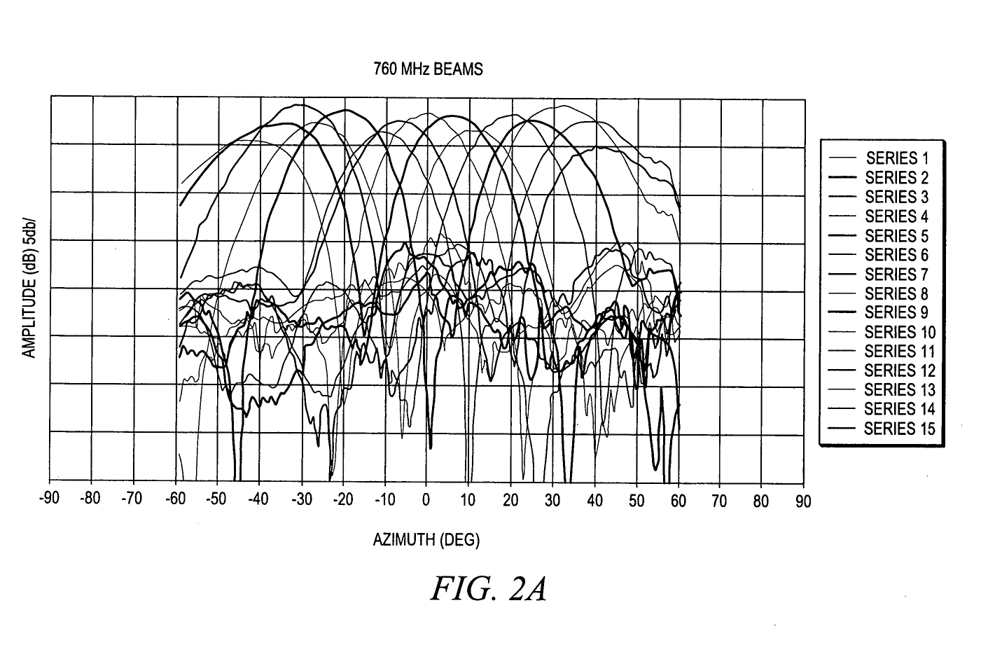

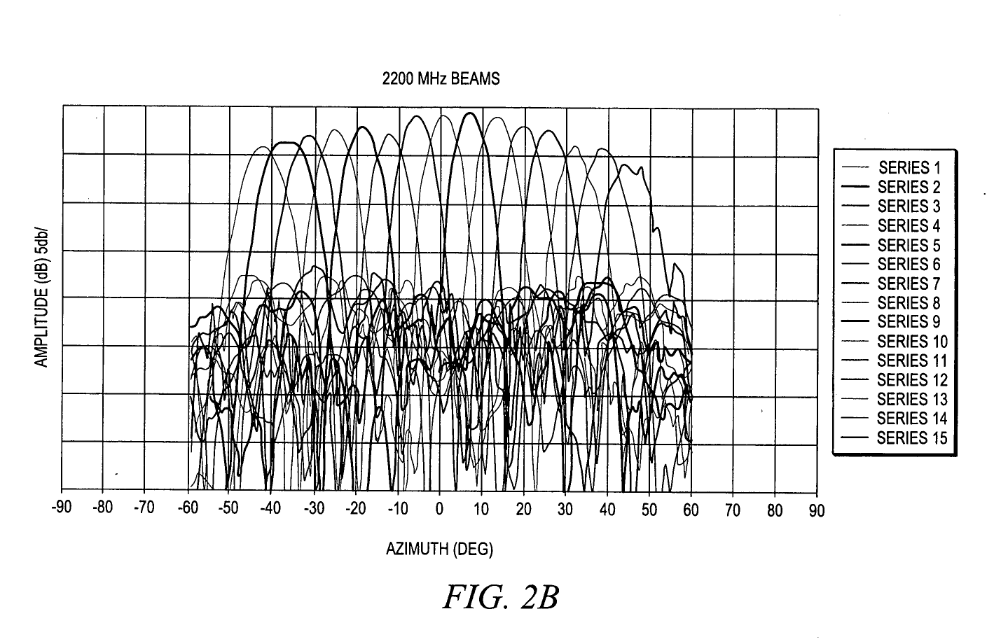

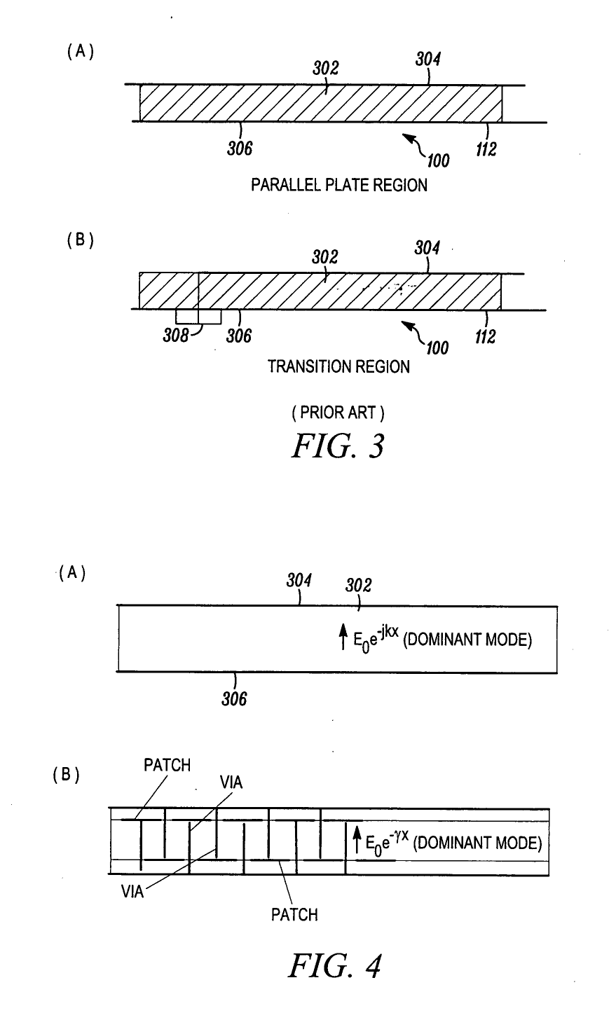

The unit cell and the artificial dielectric 1700 of FIG. 17, along with the other embodiments described herein, is suitable for use in a Rotman Lens device. As was illustrated in FIG. 1, a Rotman Lens conventionally includes a parallel plate region 108 and transition regions 110. The transition regions are generally between the parallel plate region 108 and the input ports 102, output ports 104 and load ports 106. The transition regions 110 operate electrically to transform the dominant mode into a coaxial probe current.

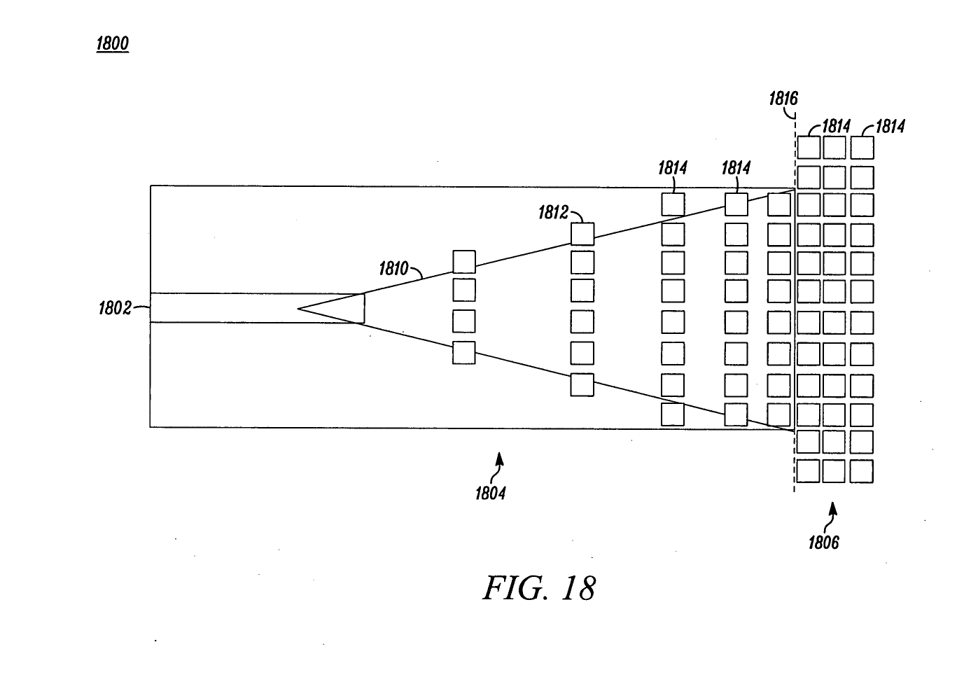

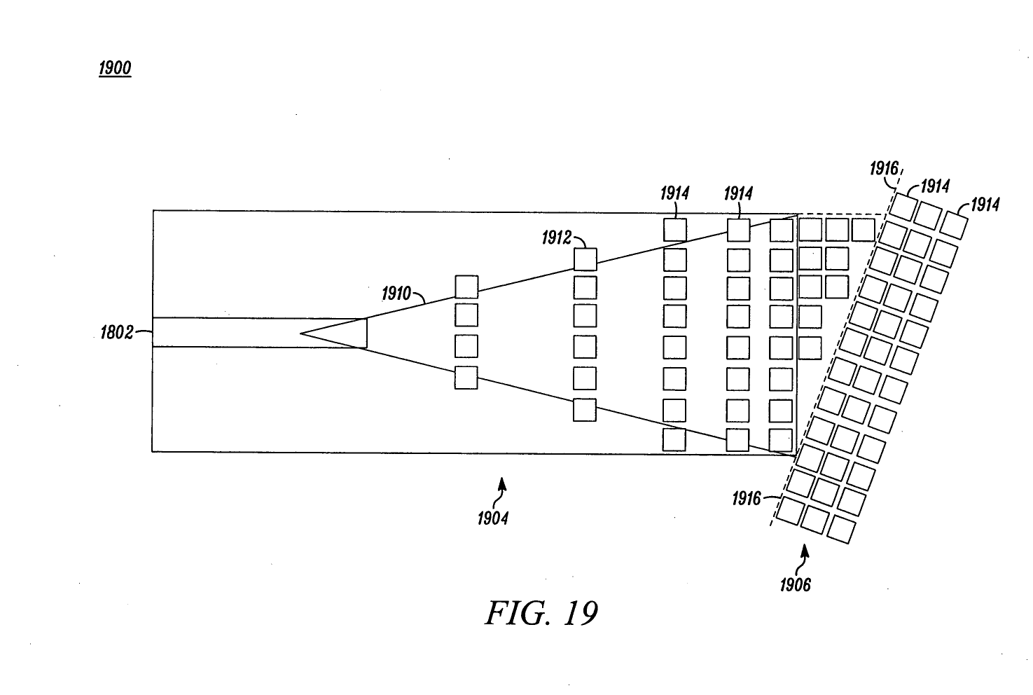

Two embodiments of transition regions are shown in FIGS. 18 and 19. FIG. 18 is a top view of a portion 1800 of an artificial dielectric Rotman Lens. The portion 1800 includes an input 1802, a transition region 1804 and a parallel plate region 1806. A border 1816 is shown in the diagram to illustrate the boundary between the transition region 1804 and the parallel plate region 1806.

The input 1802 in FIG. 18 is in the form of a microstrip port having a characteristic impedance of 50Ω. For other applications, other types of inputs or other impedances may be selected.

The transition region 1804 includes a flare profile 1810 and a capacitive profile 1812. The flare profile is formed of metallization on the printed circuit board. The flare profile 1810 extends from the relatively narrow microstrip input port 1802 to the relatively wide parallel plate region 1806. The flare profile 1810 may have any suitable shape. A linear shape is shown in FIG. 18, but an exponentially profiled shape or any other suitable shape may be used. The particular shape may be varied as part of the design in order to vary or optimize design characteristics of the Rotman Lens using the transition region. The transition regions transform the a characteristic impedance of 50Ω of the microstrip input port to the lower impedance of the parallel plate region 1806.

The capacitive profile 1812 includes a plurality of unit cells 1814 such as those described above in conjunction with FIGS. 14-17. The design of the transition may be tailored by varying features such as the unit cell size and spacing, width of metallic patches, and so on. The embodiment illustrated in FIG. 18 is exemplary only.

The parallel plate region 1806, or bulk region, is designed to have a dielectric constant of approximately 75 over an operational frequency range of 600 to 2600 MHz. This is achieved using the design techniques described herein. The parallel plate region 1806 is formed using an array of unit cells 1814 as shown diagrammatically in FIG. 18.

In FIG. 18, the parallel plate region lattice and transition region lattice are both isomorphic to the border 1816 between these regions. That is, they have substantially the same shape or, in the illustrated embodiment, the array of unit cells 1814 in the parallel plate region 1806 aligns with the unit cells 1814 in the transition region 1804 across the border 1816

In FIG. 19, the transition region 1904 and the parallel plate region 1906 are non-isomorphic to the border 1916 and consequently interfering cells (along with their patches and vias) must be eliminated. FIG. 19 is a top view of a portion 1900 of an artificial dielectric Rotman Lens. Similar to the portion 1800 of FIG. 19, the portion 1900 of FIG. 19 includes an input 1902, a transition region 1904 and a parallel plate region 1906. A border 1916 is shown in the diagram to illustrate the boundary between the transition region 1904 and the parallel plate region 1906.

Portion 1800 of FIG. 18 and portion 1900 of FIG. 19 are to be formed on a printed circuit board or other suitable material. Because the Rotman Lens structure requires that input ports and output ports be positioned in an arc, some of the transition regions will be generally linear, like the portion 1800 of FIG. 18. Also, some transition regions will require curvature or a bend from the input to the parallel plate region 1806. FIG. 19 illustrates one embodiment in which this can be achieved. The transition region includes a step-wise merger of two different cell regions in the transition region and in the parallel plate region.

As noted above, the arrangement of cells 1814, 1914 in the transition region 1804, 1904 is tailored to accommodate the geometries created by the angle to the parallel plate region. In the illustrated embodiment of FIG. 19, excess cells 1914 are removed from the transition region 1904 so that the cells 1914 of the transition region continue to align with the cells of the parallel plate region 1906.

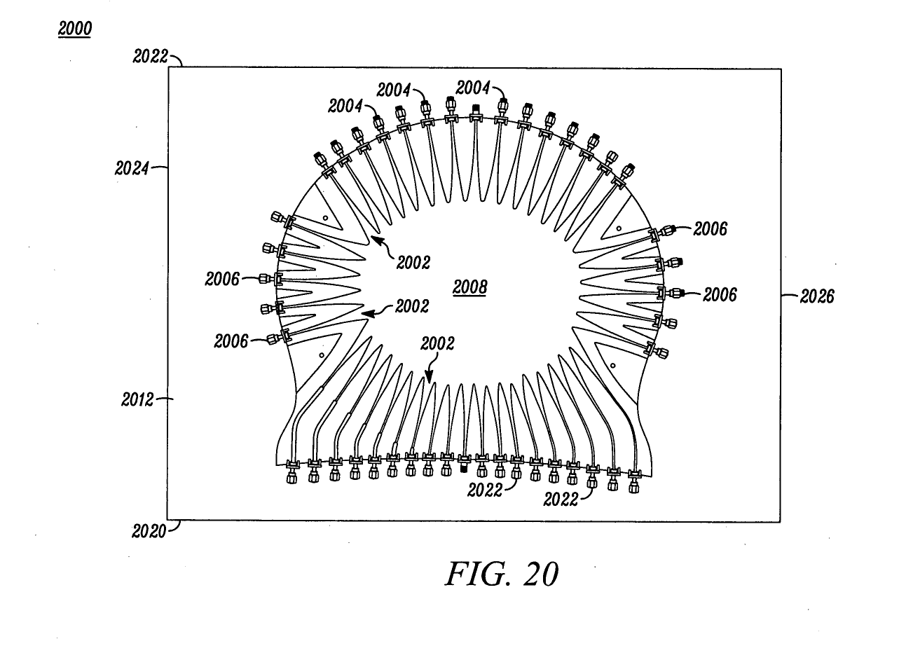

FIG. 20 illustrates an artificial dielectric Rotman Lens (ADRL) 2000 in accordance with the presently disclosed embodiments. The ADRL 2000 includes beam input ports 2002, beam output or antenna ports 2004, dummy or load ports 2006, a parallel plate region 2008 and transition regions 2010.

The ADRL 2000 is formed using a printed circuit board 2012 having metallization on a dielectric material. The printed circuit board 2012 includes a plurality of dielectric layers and conducting layers. The conducting layers may be formed on the surfaces of the printed circuit board 2012 or on layers within the board structure. Each conducting layer may be patterned in conventional fashion, for example to produce arrays of conducting patches. Further, conducting vias may be formed in the printed circuit board 2012 in any conventional fashion. Together, the patches and vias form an artificial dielectric material. The patches and vias may be located throughout the printed circuit board 2012 or may be confined to the parallel plate region 2008 and portions of the transition regions 2010.

The input ports 2002 are placed along a first side 2020 of the board 2012 forming the ADRL 2000. The output ports 2004 are positioned along an opposite 2022 of the board 2012. The dummy ports 2006 are located along the other sides 2024, 2026 of the board 2012.

In the ADRL 2000, typically one or more input ports 2002 are selected and/or combined, thus producing a distribution of radio frequency (RF) energy across the output ports 2004. The dummy ports 206 placed on the sides 2024, 2026 of the ADRL 200 are ultimately loaded with lossy terminations to reduce reflections. By selection of respective input ports 2002, certain output ports 2004 are also selected. A beam of energy leaves the ADRL 2000 at a particular azimuth depending on the selected output ports 2004. Thus, a variety of beams each with a different azimuth may be formed using the ADRL 2000.

It is therefore intended that the foregoing detailed description be regarded as illustrative rather than limiting, and that it be understood that it is the following claims, including all equivalents, that are intended to define the spirit and scope of this invention.

1. An artificial dielectric Rotman Lens (ADRL) comprising:
input ports;
output ports;
a parallel plate region which includes an artificial dielectric material; and
transition regions between respective input ports and respective output ports and the parallel plate region.

2. The ADRL of claim 1 wherein the artificial dielectric material has a permittivity substantially equal to permittivity of a dense homogeneous material.

3. The ADRL of claim 1 wherein the artificial dielectric material comprises an array of capacitive elements formed between adjacent conducting layers.

4. The ADRL of claim 1 wherein the artificial dielectric material comprises one or more dielectric slabs sandwiched between adjacent conducting layers.

5. The ADRL of claim 4 wherein the artificial dielectric material comprises an array of conducting patches and associated vias extending at least part way through the one or more dielectric slabs.

6. The ADRL of claim 1 wherein the artificial dielectric material is selected to provide substantial linearity in a plot of permittivity versus applied frequency for an operational frequency of interest for the Rotman lens.

7. The ADRL of claim 1 further comprising a printed circuit board on a surface of which the input ports and the output ports are disposed and in a portion of which the artificial dielectric material is formed.

8. The ADRL of claim 7 wherein the printed circuit board comprises a central area in which the parallel plate region is formed, the central region including a periodic array of conductive patches and conductive vias to adjust the permittivity of the parallel plate region.

9. The ADRL of claim 8 wherein the transition regions each comprise:
a flare profile; and
a capacitive profile.

10. The ADRL of claim 9 wherein the capacitive profile includes a plurality of cells forming capacitive loads defined by the conductive patches and conductive vias.

11. The ADRL of claim 10 wherein the parallel plate region comprises a second plurality of cells forming capacitive loads defined by the conductive patches and conductive vias.

12. The ADRL of claim 10 wherein the plurality of cells in the transition regions is step-wise merged with the second plurality of cells in the parallel plate region.

13. An artificial dielectric Rotman Lens (ADRL) comprising:
a printed circuit board including a plurality of dielectric layers and a plurality of conducting layers;
one or more arrays of capacitive elements formed from the plurality of dielectric layers and the plurality of conducting layers to define a parallel plate region of the Rotman lens;
input ports disposed on the printed circuit board;
output ports disposed on the printed circuit board; and
transition regions between the parallel plate region and the input ports and the output ports.

14. The ADRL of claim 13 wherein the one or more arrays of capacitive elements comprise unit cells, each unit cell including at least one conducting patch formed in one of the conducting layers and at least one via extending at least partially through the printed circuit board.

15. The ADRL of claim 14 wherein the unit cells are periodic in two directions on the printed circuit board.

16. The ADRL of claim 14 wherein the unit cells are aperiodic in at least one direction on the printed circuit board.

17. The ADRL of claim 13 wherein the transition regions include capacitive elements positioned to align with capacitive elements in the parallel plate region.

18. The ADRL of claim 17 wherein the capacitive elements of the transition regions are step-wise merged with adjacent capacitive elements of the parallel plate region.

19. The ADRL of claim 13 wherein the one or more arrays of capacitive elements are arranged to provide substantial linearity in a plot of permittivity versus applied frequency for an operational frequency of interest for the Rotman lens.

20. The ADRL of claim 19 wherein the permittivity of the parallel plate region is greater than permittivity of an unloaded material configuration for an operational frequency as large as possible.

21. The ADRL of claim 19 wherein the permittivity of the parallel plate region is at least 75 for an operational frequency in the range 600 to 2600 MHZ.
